(19) United States
(12) Patent Application Publication
(10) Pub. No.: US 2007/0217972 A1
(43) Pub. Date: Sep. 20, 2007

(54) Apparatus for production of hydrogen

(76) Inventors: Daniel N. Greenberg, Seattle, WA (US); Jasbir Kaur Anand, Seattle, WA (US); James D. Whitt, Seattle, WA (US)

Correspondence Address: TODD N. HATHAWAY, 119 N. COMMERCIAL ST. #620, BELLINGHAM, WA, 98225, US

(21) Appl. No.: 11/698,411

(22) Filed: Jan. 26, 2007

Related U.S. Application Data
(60) Provisional application No. 60/762,568, filed on Jan. 27, 2006.

(51) Int. Cl. B01J 8/08; B01J 7/00

(52) U.S. Cl. 422/232; 48/61

(57) ABSTRACT

An apparatus for generating hydrogen from a controllable water-split reaction. The reaction utilizes a consolidated mass of reactant material, comprising aluminum and a metal oxide initiator, and preferably a water soluble salt catalyst that causes progressive pitting of the aluminum during the reaction. The reactant materials are in particulate form, and are contained within a layer of filter material that allows the water to enter and the hydrogen gas to escape. Water is fed into the mass in a progressive fashion, from one end towards the other. The produced hydrogen is collected and supplied to a fuel cell or other user device. The mass of reactant material may be contained in a replaceable cartridge.

### RELATED CASES

This application claims the priority of Provisional Patent Application Ser. No. 60/762,568, filed 27 Jan. 2006.

### BACKGROUND

a. Field of the Invention

The present invention relates generally to apparatus for the production of hydrogen, and, more particularly, to a self-contained apparatus for producing hydrogen by means of a water-split reaction, over a sustained period and in a controllable manner based on the demands of a fuel cell or other user device.

b. Related Art

Hydrogen holds great potential as a “clean” fuel, particularly for use in fuel cells. However, as is well known, a number of drawbacks inherent in current methods for production and supply of hydrogen have heretofore stymied the widespread use of hydrogen as a fuel.

The most common methods of producing hydrogen have been extraction from fossil fuels, such as natural gas or methanol, and electrolysis (i.e., passing electric current through water to disassociate the molecules). Both methods suffer from serious inefficiencies, and furthermore, hydrocarbons represent a nonrenewable and increasingly expensive resource. Moreover, these processes commonly require a comparatively large, stationary plant, so that subsequent storage and transportation of the hydrogen to the end user (e.g., in compressed tanks) is expensive, complex and potentially dangerous. In some instances, particularly in the case of vehicles, hydrogen has been extracted from a liquid hydrocarbon fuel (e.g., gasoline and/or methanol) that is carried in a non-pressurized tank; while perhaps less dangerous than transporting hydrogen under pressure, such systems have remained costly and complex, and moreover produce environmentally undesirable emissions in the form of carbon dioxide, monoxide and other gasses.

Hydrogen may also be generated on a stationary or portable basis, by chemical reaction. As is well known, hydrogen can be produced by reaction between water and certain metal hydrides, including lithium hydride (LiH), lithium aluminum hydride (LiAlH₄), lithium borohydride (LiBH₄), sodium hydride (NaH), sodium aluminum hydride (NaAlH₄) and sodium borohydride (NaBH₄). However, the reactions are highly exothermic and potentially dangerous, so that the rate at which water is combined with the chemical hydride must be precisely controlled in order to avoid a runaway reaction and potential explosion. Achieving such control has proven elusive: Most efforts have focused on the use of catalysts, however, it has been found that when the reactions are controlled at levels that avoid runaway exothermic conditions they become unacceptably inefficient, due in part of accumulation of reaction products on the catalysts. Other attempts at controlling water-chemical hydride reactions have taken the approach of physically separating the reactants (e.g., using membranes), but have generally proven impractical.

Hydrogen can also be produced by the simple reaction of water with alkaline metals, such as potassium or sodium. However, these reactions are not just exothermic but in fact violent, making them even more difficult to control than the water-metal hydride reactions described above. Moreover, the residual hydroxide product (e.g., KOH) is highly alkaline, corrosive and dangerous to handle, as well as being hazardous to the environment. However, attempts to use metals having more benign characteristics (e.g., aluminum) have largely been stymied by the tendency of reaction products to deposit on the surface of the metal, blocking further access to the surface and bringing the reaction to a halt in a phenomenon known as “passivation”.

Additional factors include the operating requirements and parameters of the user devices. Fuel cells are optimal for many applications, due to their versatility and essentially emissions-free operation. However, fuel cells are sensitive to supply pressures, i.e., the pressure of the H₂ supplied to the fuel cell must be kept relatively low (typically less than about 50 psig) in order to avoid damage to the membranes and other components; in order to avoid the need for complicated and expensive pressure controls, it is therefore desirable that the hydrogen-producing reaction be capable of operating efficiently at low or near-ambient pressures. Moreover, the device to which power is supplied by the fuel cell may be operated on an intermittent basis, e.g., the device may be a piece of electronic equipment that is energized when needed and then de-energized; consequently, it is important that the supply device be able to regulate the rate of the reaction, or even shut down completely and then restart successfully, or else the fuel (i.e., the reactant materials) may be consumed uselessly. However, for reasons including those which have been discussed, it has been generally impractical for hydrogen production devices to meet such requirements using the reactions described above.

Moreover, it is important for many applications that the hydrogen generating apparatus be sufficiently compact that it can be readily transported in association with the user device. For example, it may be important that the generator be sufficiently small that it not compromise the portability of a piece of electronic equipment. Again, however, such a goal has proven elusive with prior reactions and generators.

Accordingly, there exists a need for an apparatus for generating hydrogen that employs a water-split reaction that is safe and environmentally benign in character. Furthermore, there exists a need for such an apparatus in which the rate of reaction and production of hydrogen can be controlled, or stopped entirely and then restarted, in order to efficiently meet the demands of the user device. Still further, there exists a need for such an apparatus that is capable of generating hydrogen at low or near-ambient pressures, so as to be able to produce a flow of hydrogen at pressures suitable for use by a fuel cell without requiring complicated pressure controls. Still further, there exists a need for such an apparatus that is sufficiently compact that it is readily transportable, either by itself or in conjunction with portable user equipment.

### SUMMARY OF THE INVENTION

The present invention has solved the problems cited above, and is an apparatus for generating hydrogen from a controllable water-split reaction.

Broadly, the apparatus comprises: (a) a consolidated mass of reactant material, with the reactant material comprising at least metallic aluminum and a metal oxide initiator; (b) means for selectively introducing water to the mass of reactant material, so as to controllably produce a reaction therewith that generates hydrogen gas; (c) means for permitting the hydrogen gas to escape from the mass of reactant material; and (d) means for supplying the hydrogen gas to a fuel cell or other user device.

The means for introducing a flow of water into the mass of reactant material may comprise a selectively operable pump for supplying water from a reservoir to the mass of reactant material. The apparatus may further comprise means for actuating operation of the pump in response to a sensed drop in pressure of the hydrogen supplied to the user device. The means for actuating the pump may comprise a pressure switch.

The consolidated mass of reactant material may comprise: (a) an elongate body containing the mass of reactant material, and (b) means for feeding water into the body progressively from a first end thereof. The body may comprise a filter body having a mesh material surrounding the particulate reactant material. The means for feeding the water to the reactant material may comprise a blotter member for distributing the water across the first end of the body. The body may be housed in an impervious sleeve that ensures progressive flow of water along and into the reactant material. The means for allowing the hydrogen to escape from the mass of reactant material may comprise a porous member that is mounted over the second end of the body.

The apparatus may further comprise a reactor assembly having an outer shell that encloses the mass of reactant material. The outer shell may comprise an internal chamber for receiving the hydrogen that is released from the reactant cartridge. The reactor shell may also comprise a reservoir for the water that is supplied to the cartridge.

The reactant material may further comprise a water-soluble salt catalyst for causing progressive pitting of the aluminum, in addition to the metallic aluminum and metal oxide initiator.

These and further features and advantages of the invention will be more fully understood from a reading of the following detailed description with reference to the accompanying drawings.

### BRIEF DESCRIPTION OF THE DRAWINGS

FIG. 1 is a schematic view of a hydrogen generation apparatus in accordance with the present invention, showing the main reactor assembly in association with the control mechanisms of the apparatus;

FIG. 2 is a cross-sectional view of the cartridge of reactant material that is housed within the reactor vessel of the apparatus of FIG. 1;

FIG. 3 is a cross-sectional view of a reactor in accordance with a second embodiment of the present invention, showing the use of multiple reactor cartridges rather than the single cartridge that is shown in FIG. 1;

FIG. 4 is a cross-sectional view of a reactor cartridge in accordance with another embodiment of the invention, having a revised construction as compared with the cartridges of FIGS. 1-3;

FIG. 5 is a graph showing the production of hydrogen and related data, for a hydrogen generation apparatus in accordance with the present invention when operated at ambient pressure;

FIG. 6 is a second graph, similar to FIG. 5, showing hydrogen production. and other data for the apparatus when operated at a pressure of 30 psig;

FIG. 7 is a graph of hydrogen production and other data from operation of a prototype reactor in accordance with the present invention, showing the manner in which water is selectively supplied to the reactant materials in response to a sensed drop in the pressure of the hydrogen; and

FIG. 8 is a bar graph of percentage yield of hydrogen for several reactions conducted under near identical conditions, showing a consistent yield of about 80 percent.

### DETAILED DESCRIPTION

The present invention produces hydrogen by means of an aluminum-based water split reaction, utilizing solid reactant materials in a replaceable cartridge. The cartridge is installed in a reactor vessel, having a supply of water which is selectively fed to the cartridge to produce the hydrogen-generating reaction.

In the following sections, the reaction and materials will be described first, followed by a description of the apparatus and its operation.

a. Reaction

The present invention reacts a mixture of metallic aluminum and a metal oxide initiator with water to generate hydrogen at ambient temperatures and pressures, and at neutral or near neutral pH levels. A salt catalyst prevents passivation of the metallic aluminum, and may either be blended into the reactant material contained in the cartridge, or in some instances may be leached out prior to use. The reactants are therefore able to achieve a rapid and efficient water split reaction using (for example) ordinary tap water, without requiring preheating. Furthermore, complex regulation of the reactants is not needed.

The initiator is suitably an alkaline earth metal oxide, such as calcium oxide (CaO). The catalyst is suitably an alkali salt, such as sodium chloride (NaCl) or potassium chloride (KCl). The particle size is preferably in the range from about 0.01 mu.m. to about 1,000 mu.m.

The mixture is stable, in the absence of water, and is easily transported without being hazardous.

The reaction can initiate at ambient temperatures. The starting pH is suitably in the range of about 4-8, preferably in the range of about 5-7.5, and remains substantially neutral (i.e., in the range of about 4-10) for the duration of the reaction. The reaction proceeds for the mass ratio of aluminum to calcium oxide or alkali salts, varying over the range of a few percent up to 99 percent of the catalyst/additives.

The principle products of the reaction are hydrogen (H₂), aluminum hydroxide (Al(OH)₃), aluminum oxyhydroxide (AlOOH), calcium hydroxide (Ca(OH)₂), and calcium oxide (CaO), all of which are substantially benign in character. Aluminum can be regenerated from the aluminum hydroxide, i.e., the reaction product is recyclable.

As is well known, metallic aluminum reacts with water to generate hydrogen, but also forms Al(OH)₃, AlOOH, and/or Al2O₃. These three chemicals tend to deposit on the metal surface and restrict further reaction of water with the metal; this tendency, referred to as “passivation”, is an important property of Al metal, and preserves the metal from further corrosion under neutral conditions. Passivation of aluminum consequently plays a significant role inhibiting the hydrogen generation from water and aluminum under near-neutral pH conditions.

The present invention prevents the development of passivation, by exposing the aluminum to water-soluble inorganic salts, particularly halide salts, that act as catalysts to create a sequential pitting process. Pitting corrosion is initiated by aggressive anions like chlorides, nitrates, and sulfates or alkali or alkaline earth metals.

The catalysts are consequently selected from water-soluble inorganic salts, primarily the halides, sulfides, sulfates and nitrates of Group 1 or Group 2 metals and their mixtures. The preferred water-soluble catalysts include NaCl, KCl, and NaNO3, in pure or combined form; NaCl is generally most preferred, owing to its high solubility, efficacy and low cost, as well as its benign health and environmental characteristics; KCl is also inexpensive and effective, however, it is a suspected mutagenic compound and therefore less desirable from a safety standpoint. Other catalysts that may be employed include alumina, ESP (a waste product available from Alcoa Inc., USA), aluminum hydroxide and aluminum oxide, generally in combination with one or more of the preferred salts identified above. Using NaCl, the metal-to-salt ratio is preferably about 1:1 by weight ratio, although ratios in the range from about 9:1 to 1:9 may be employed in some instances.

The initiator is suitably an alkaline earth metal oxide; other metal oxides may be employed, but many yield reaction products that interfere with the aluminum-water split reaction, or that are undesirable from a safety or environmental standpoint. CaO, MgO and BaO are preferred, with CaO being most preferred, due again to its efficacy and the benign nature of the material and its reaction products. The initiator serves to raise the temperature of the material when exposed to water; the increase above ambient temperatures is sufficient to reach a level at which the water-aluminum reaction initiates, thus obviating the need for preheating, however, the effect is modest and safe by comparison with the other exothermic reactions described above.

The aluminum and water soluble inorganic salt may be mechanically alloyed or blended, thus enabling the water soluble salt to perform most effectively as a catalyst to support the water split reaction. Blending the metal and catalyst in the form of very fine particles (e.g., from about 10 to 1000 um) produces the high yields and rates of production; suitable particle sizes can be achieved by various milling techniques including, for example, Spex milling, rotor milling, attrition milling and ball milling. Pre-milling of the catalysts further reduces the particle size and can therefore enhance its effectiveness.

The catalyst is preferably pre-milled to reduce its particle size, and the aluminum powder is blended in. During the milling process the metal is deformed plastically, so that the constituents become mechanically alloyed. Mechanically alloying the salt and the metallic aluminum ensures intimate contact between the two as the metal is eroded during the reaction process, causing continuous exposure of fresh Al surfaces for reaction with the water; in general, the metal oxide initiator is included as a separate particulate that is mixed with the alloyed aluminum-salt particulate, to ensure more immediate and rapid contact with the water, however, in some embodiments it too may be mechanically alloyed with the aluminum and salt.

The reactant material in the cartridge may therefore include all three of the above components, i.e., the metallic aluminum, the metal oxide and initiator and the salt catalyst. However, as part of the present invention, it has been found that the reaction can proceed and produce satisfactory yields in instances where the salt is leached out of the material prior to use. In essence, the salt “pre-pits” the metallic aluminum, so that the water-split reaction will proceed to a satisfactory extent without an ongoing “progressive pitting” process. In such instances, the reactive material is composed of the metallic aluminum and metal oxide initiator, the salt component having previously been reacted and then leached out of the aluminum by water (or other suitable liquid). The advantage of the “leached out” fuel material is potentially higher energy density, due to the fact that the salt is not actually included in the materials within the cartridge. The disadvantage is potentially lower H₂ yields (due to eventual passivation), as compared with those instances where the salt is included in the reactive material.

b. System

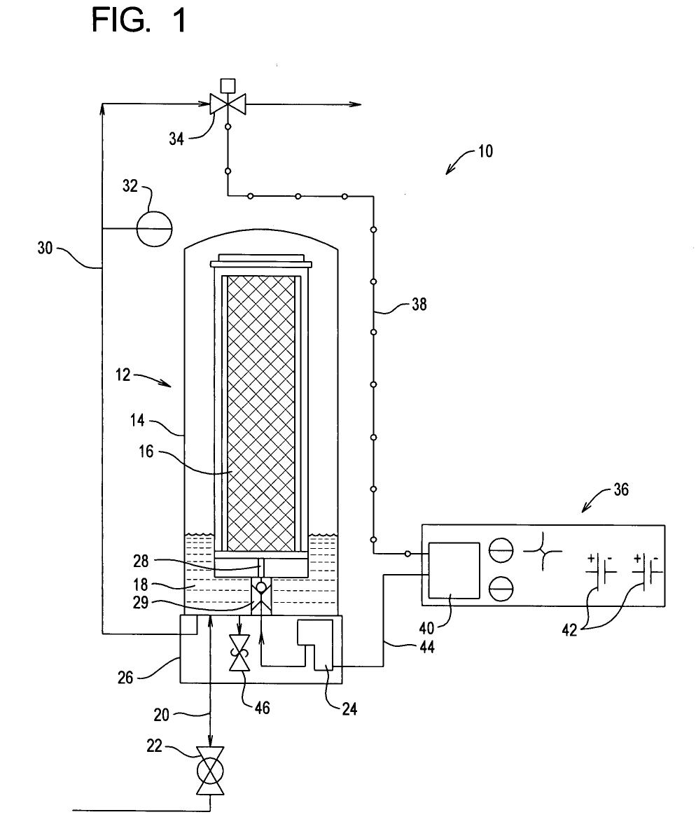

FIG. 1 shows a self-contained hydrogen generation system 10 in accordance with the present invention.

As can be seen, the core component of the system is a generator assembly 12. The generator includes a reactor shell 14 that encloses a replaceable reactant material-filled cartridge 16. In the illustrated embodiment, both the cartridge and shell are vertically elongate members, mounted in generally concentric relationship, with the shell suitably being formed of a polycarbonate or similar durable, corrosion resistant material.

Water is contained in a reservoir 18 at the base of the water is supplied to the reservoir via a fill line 20 and valve 22; it will be understood that the water may be supplied from a tank associated with the system, or from an external source.

Water is drawn from the reservoir 18 by a pump 24, that is suitably enclosed in a housing 26 at the base of the reactor assembly, and forced upwardly into the reactor cartridge via an inlet pipe 28 and quick-connect fitting 29 at the base end thereof. Water entering the cartridge contacts the reactive materials therein (i.e., the metallic aluminum and metal oxide initiator, with or without the salt catalyst, as described above), resulting in the production of hydrogen gas; as will be described below, the reaction continues so long as water is supplied to the cartridge (until the solid reactive material is exhausted), and can be stopped and restarted as necessary. The hydrogen gas is contained by the reactor shell 14 and is drawn from the generator via pressure line 30, with the pressure optionally being monitored by a gauge 32; a safety relief valve 46 is also provided at the reactor vessel.

A pressure switch 34 is also mounted in the hydrogen line, upstream of the fuel cell or other user device. The pressure switch responds to a drop in the line pressure (i.e., a drop in pressure that is caused by demand for hydrogen by the user device), and outputs a signal to the system control unit 36 via line 38. The signal is received by a control board 40 in the system controller that in turn actuates the pump 24 by supplying power thereto from onboard batteries 42, via lead 44. So long as the pressure remains below a predetermined limit, operation of the pump, and therefore production of hydrogen, continues. Upon the pressure rising above the limit, indicating that a demand for hydrogen has been satisfied, the signal is discontinued and power is cut off to stop operation of the pump; the cessation may be brief, simply until continued operation of the user device again draws down the hydrogen in the line, or it may be of an indefinite duration if operation of the user device has ceased.

The system therefore consumes the reactant materials only when there is a demand for the hydrogen output. When the user equipment is not in operation, the hydrogen-generating system remains inactive and capable of producing additional hydrogen, until the reactant materials are fully exhausted. At such time, the expended cartridge is simply removed and replaced with a fresh cartridge of reactant material. The reaction products, in turn, are simply drained out of the reactor vessel; as noted above, the reaction products are safe and environmentally benign, and may be recycled if desired.

The pressure supplied to the fuel cell or other user device can be controlled by means of the pressure switch and electronic controls, as described above, or a regulator valve or similar device may be used.

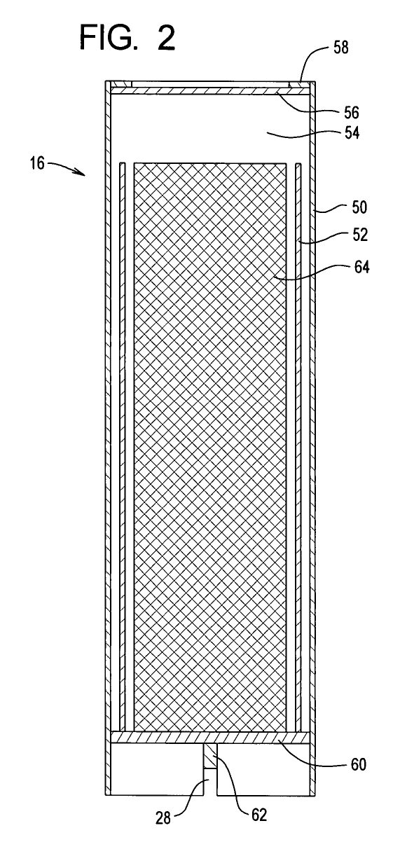

FIG. 2 shows the construction of the cartridge 16 in greater detail.

In the illustrated embodiment, the cartridge is a generally cylindrical member, suitably having a diameter of about 1″ and a height of about 4″. A cylindrical tube 50 of polycarbonate or other suitable rigid, corrosion resistant material forms the outer body of the cartridge. An inner mica sleeve 52 is mounted concentrically within the outer housing, and is slightly shorter than the housing so that there is a spaced gap 54 between the upper ends of the tube. The upper end of the housing is covered by a porous PTFE membrane 56 or other gas permeable member, secured in place by an annular retainer 58 that is mounted about its edge. The lower end of the housing is closed by the disk 60 of blotter material that is in contact with a central wick 62, the latter in turn being in communication with the water inlet line 28 from the pump.

The solid, particulate reactant material is contained in a filter body 64 that is located within the interior sleeve 52. The filter body contains the powdered reactant material in a consolidated mass, while allowing water to enter and hydrogen to escape, and is suitably constructed of a fine plastic (e.g., PVC) mesh. The consolidated material may be loosely packed within the body or tightly compacted, depending on desired reaction rates, designed cartridge life, size constraints, and other design factors; moreover, in some instances it may be formed into a more or less solid, porous and/or friable mass.

In operation, water supplied from the pump via line 28 enters the base of the cartridge and flows through wick 62, which dissipates the flow somewhat and prevents damage to the blotter disk 60; the wick is suitably formed of a fibrous material that conveys the water therethrough, however, it will be understood that other materials or forms of conduit may be used. The water flows from the wick into the blotter disk, which serves to distribute the flow across the entire base end of the inner sleeve and filter body. The blotter disk is suitably formed of blot paper, sometimes referred to as a blotter filter paper, which is a cotton fiber paper available from numerous sources (e.g., Bio-Rad Laboratories, Inc., Hercules, CA); it will be understood, however, that other materials that spread and distribute the water across the end of the sleeve and body may be used, such as various other fibrous, sintered and foam materials, for example.

As water continues to enter via the blotter disk, the level rises more or less evenly across the lower end of the filter body, reacting with the materials therein to produce hydrogen. The hydrogen gas escapes via the porous membrane 56 at the top of the cartridge, and is drawn from the surrounding enclosure in the manner described above. When flow stops (e.g., when the pump shuts down upon cessation of demand for the hydrogen, as described above), the water remains at its existing level so that the material above it remains unreacted. When flow is reinitiated, the water continues its rise, and additional reactant material is consumed. Because the particulate reactant material is held together in a consolidated mass by the mesh of the filter body, movement of the material that might cause premature mixing and reaction with the water is avoided. In this manner, the reactant material within the filter body is consumed in an efficient, progressive manner, from the lower end to the top.

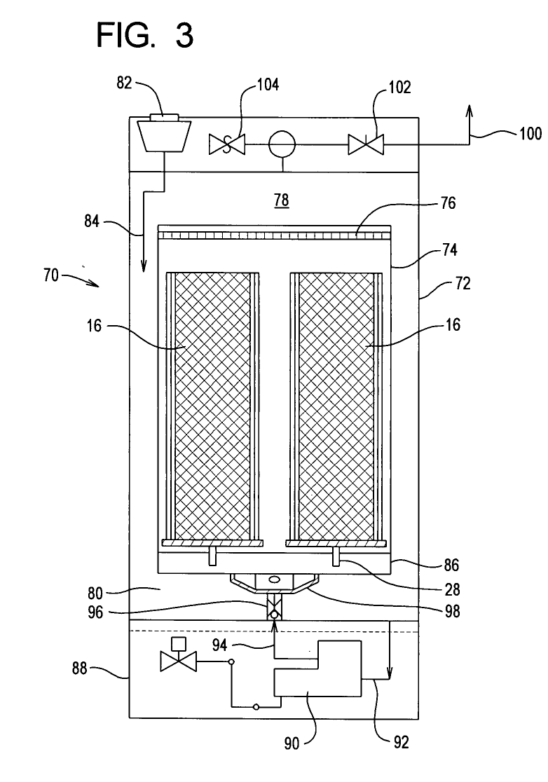

FIG. 3 shows a reactor assembly 70 in accordance with another embodiment of the invention, which differs in structure and number of cartridges from that shown in FIG. 1. This embodiment utilizes a plurality (e.g., 4-8) of the reactant cartridges of the type shown in FIG. 2. Accordingly, the reactor includes a larger diameter (e.g., approximately 3-inch) tubular housing 72 that surrounds the inner sleeve 74 holding the cartridges 16. Again, the upper end of the inner sleeve is covered by a porous membrane 76, and there is a spaced gap above the upper end of the sleeve that forms a collection chamber 78 for the hydrogen.

In this embodiment, the outer housing 72 also forms a reservoir 80, in the annular gap between it and the inner sleeve 74 and also in the space beneath the latter. Water is introduced into the reservoir via a cap 82 and fill line 84, to a level below the upper end of the inner sleeve; since the lower end of the sleeve is sealingly mounted to a base plate 86, water is prevented from prematurely entering the interior of the sleeve and reacting with the materials in the cartridges.

A base unit 88 supports and sealingly closes the lower end of the housing 72, and includes the water supply pump 90. Upon actuation, the pump draws water from the bottom of the reservoir 80 through an intake line 92, and discharges it under pressure through a second line 94 that communicates with the inlet tubes 28 of the cartridges via a quick-connect coupling 96 and ported fitting 98. The cartridges thus fill evenly from the bottom and react in a progressive fashion, in the manner described above. The resulting hydrogen is collected in chamber 78, and is drawn off and supplied to the fuel cell (or other user device) via pressure line 100; a pressure regulator 102 and pressure safety valve 104 may also be provided in the hydrogen line to prevent a possibility of over pressurization and damage to the fuel cell.

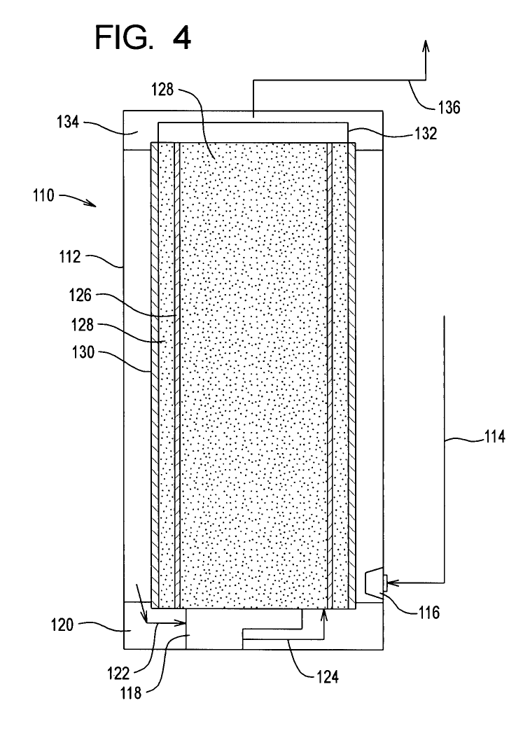

FIG. 4 shows another reactor assembly 110, using a cartridge having a form of construction differing from that described above. As with the embodiment illustrated in FIG. 3, the outer housing 112 of the reactor assembly serves as a reservoir for the water that is filled via line 114 and plug 116. Likewise, water is drawn from the reservoir and is supplied to the cartridge by a pump 118 in the reactor base 120 and via lines 122, 124. However, rather than being supplied via a wick to a blotter disk that distributes the water across the blotter of the cartridge, from which it flows upwardly, the water is fed from the pump to an open cell polymer foam layer 126 that forms a tubular sleeve about the mass of reactant material 128. The open cell foam material is in direct contact with the particulate material, so that as the water flows along the sleeve it enters the material so as to produce the hydrogen-generating reaction. However, as compared with the embodiment described above, the flow of water through the open cell foam material is largely irrespective of gravity (being more in the nature of a capillary-type flow), hence operation of the reactor is generally independent of the orientation, i.e., it need not be maintained in a constant vertical alignment.

The porous, open cell transport layer 126 is surrounded by a cylindrical sleeve 128 formed of a closed cell porous polymer, with a non-porous composite facing 130. The use of the porous polymer for this later reduces bulk density and provides a higher R value, thus increasing reaction yields. The composite facing, in turn, provides structural support while at the same time providing a significant reduction in mass. Furthermore, an elastomeric foam material may be used for the outer shell 112.

Hydrogen produced by the reaction exits the top of the cartridge via a porous PTFE end membrane 132, and collects in an overlying chamber 134. Similar to the embodiments described above, the gas is drawn from the chamber and supplied to the fuel cell via a pressure line 136. The water supplied to the reactor assembly, via line 114, may in turn include water recuperated from the gas stream and fuel cell exhaust, in order to decrease overall system volume and mass.

c. Hydrogen Production

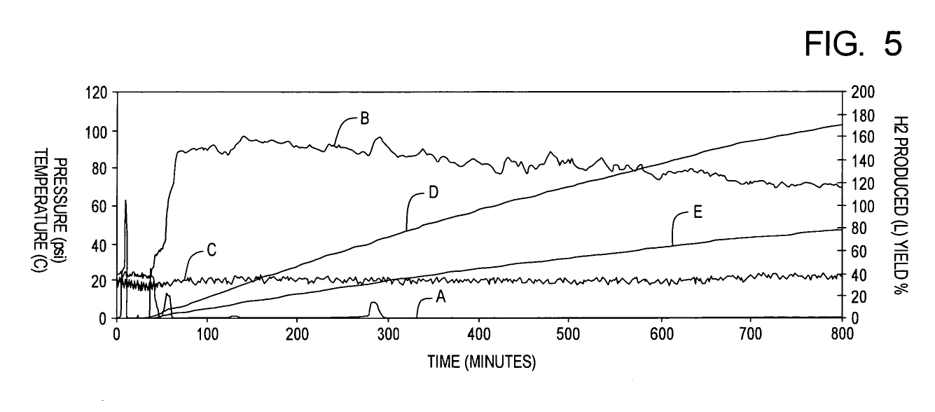

The graphs in FIGS. 5-7 present the data from operation of prototype apparatus constructed in accordance with the above description, operating under different conditions.

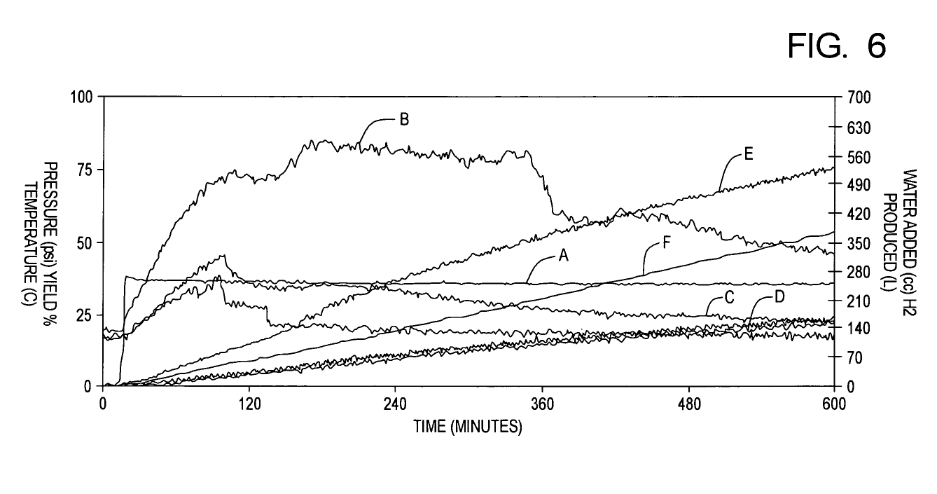

FIGS. 5 and 6 demonstrate the ability of the apparatus to operate efficiently at both near-ambient and low pressures, and therefore the ability to supply hydrogen at pressures within the parameters required by conventional fuel cells. The graphs also demonstrate the ability of the reactors to generate hydrogen on a sustained basis over an extended period of usage, i.e., 600-800 minutes or more.

FIG. 5 shows the results of operation of the apparatus at ambient pressure. Accordingly, it can be seen that the pressure (Plot A) lies substantially on the horizontal axis, i.e., a generally constant 0 psi. Commencement of the reaction, upon initiating the flow of water, is shown by the rapid rise in temperature (Plot B), which then stabilizes at approximately 80° C.; as noted above, the temperature rise is generated by the metal oxide initiator when exposed to water, the water itself being supplied at ambient temperature, i.e., approximately 20° C. (Plot C). A steady volumetric flow of hydrogen (Plot D) was produced over a period in excess of 800 minutes, with total yield percent reaching 80% (Plot E).

FIG. 6 presents corresponding data for operation of the apparatus at a controlled pressure of 30 psi (Plot A). The temperature progression (Plot B) is substantially similar to that in FIG. 5. Similarly, the graph shows steady hydrogen production (Plot D) over the duration (600+ minutes) and yield percent reaching about 80% (Plot E). FIG. 6 also shows the amount of water added (Plot F), from which it can be seen that reaction and generation of hydrogen begin immediately upon introduction of the water (average transient time from stop to full production −80 seconds).

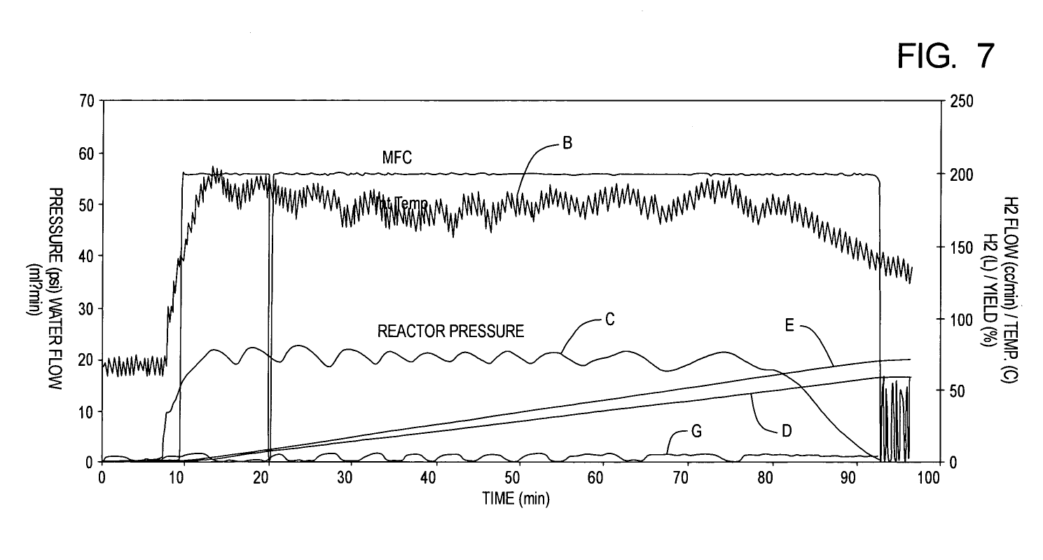

FIG. 7, in turn, shows the manner in which the water pump is actuated in response to a drop in hydrogen pressure that is sensed by the pressure switch (see FIG. 1). As can be seen, when the hydrogen pressure (Plot C) drops below a predetermined minimum (about 20 psi), the pressure switch actuates the pump, creating a flow of water to the reactant material in the cartridge (Plot G). The pressure then returns to its predetermined maximum, at which point the signal from the pressure switch ceases and the flow from the pump is stopped. FIG. 7 shows the pump (controlled by the pressure switch) operating on and off in response to changes in the reaction pressure over a comparatively short period of 90 minutes; it will be understood, however, that is the reaction pressure remains at its maximum limit for an extended period (e.g., for a period of hours or days), the pump will likewise remain inactive for this period, so that the system is simply dormant and does not consume the reactant material until such time as demand from the fuel cell or other user device again causes the pressure to drop.

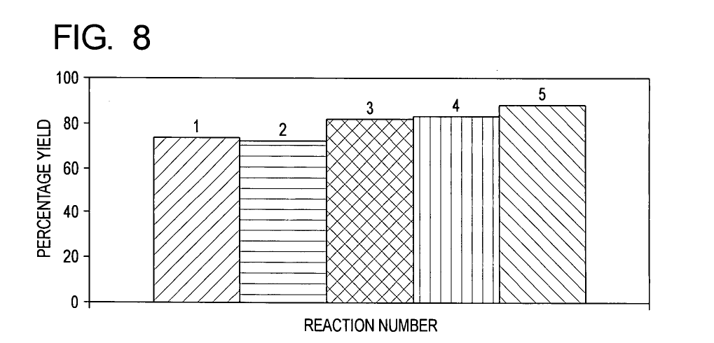

FIG. 8 shows the percentage yield of hydrogen for tests conducted using five different cartridges, reacted to full release. As can be seen, the reactions consistently produced a percentage yield of about 80%, confirming the consistent efficiency and reliability of the cartridges used in the system of the present invention.

It is to be recognized that various alterations, modifications, and/or additions may be introduced into the constructions and arrangements of parts described above without departing from the spirit or ambit of the present invention as defined by the appended claims.

What is claimed is:

1. An apparatus for generating hydrogen from a water-split reaction, said apparatus comprising:
a consolidated mass of reactant material, said reactant material comprising metallic aluminum and a metal oxide initiator;
means for selectively introducing water into the mass of reactant material so as to controllably produce a reaction that generates hydrogen gas;
means for permitting said hydrogen gas to escape from said mass of reactant material; and
means for supplying said hydrogen gas to a user device.

2. The apparatus of claim 1, wherein said means for supplying said hydrogen gas to a user device comprises:
means for supplying said hydrogen gas to a fuel cell.

3. The apparatus of claim 1, wherein said reactant material further comprises:
a water-soluble salt catalyst that causes progressive pitting of said metallic aluminum.

4. The apparatus of claim 1, wherein said means for introducing a flow of water into said mass of reactant material comprises:
a selectively operable pump for supplying water from a reservoir to said mass of reactant material.

5. The apparatus of claim 4, further comprising:
means for actuating operation of said pump in response to a sensed drop in pressure of said hydrogen gas supplied to said user device.

6. The apparatus of claim 5, wherein said means for actuating operation of said pump comprises:
a pressure switch.

7. The apparatus of claim 1, wherein said means for selectively introducing water into said mass of reactant material comprises:
means for introducing water into said mass of reactant material in a progressive manner, from one part of said mass towards a second part thereof.

8. The apparatus of claim 7, further comprising:
an elongate body containing said consolidated mass of reactant material.

9. The apparatus of claim 8, wherein said means for feeding water into said mass of reactant material in a progressive manner comprises:
means for feeding water into said elongate body from a first end of said body towards a second end thereof.

10. The apparatus of claim 9, wherein said elongate body comprises:
a permeable filter surrounding said reactant material.

11. The apparatus of claim 10, wherein said permeable filter comprises:
a layer of mesh material.

12. The apparatus of claim 10, wherein said means for feeding water into said body comprises:
means for distributing said water across said first end of said elongate body.

13. The apparatus of claim 12, wherein said means for distributing water across said first end of said elongate body comprises:
an open-cell foam member that extends across aid first end of said elongate body.

14. The apparatus of claim 12, wherein said means for distributing water across said first end of said elongate body comprises:
a blotter member that extends across said first end of said elongate body.

15. The apparatus of claim 14, wherein said means for feeding water to the reactant material further comprises:
means for supplying water to a portion of said water member from which said water is distributed by said blotter member over said first end of said body.

16. The apparatus of claim 15, wherein said means for supplying water to a portion of said blotter member comprises:
a wick member that feeds water to said portion of said blotter member.

17. The apparatus of claim 9, further comprising:
a substantially impervious sleeve in which said elongate body is housed, that ensures progressive flow of water into said reactant material.

18. The apparatus of claim 17, further comprising:
a permeable member that is mounted over said second end of said elongate body to release said hydrogen gas therethrough.

19. The apparatus of claim 18, wherein said permeable member comprises:
a porous membrane.

20. The apparatus of claim 1, wherein said means for supplying said hydrogen gas to a user device comprises:
a chamber that encloses said mass of reactant material so as to collect said hydrogen that is released therefrom.

21. The apparatus of claim 20, further comprising:
at least one replaceable cartridge containing said mass of reactant material.

22. The apparatus of claim 21, wherein said chamber encloses a plurality of said cartridges.

23. A cartridge for generating hydrogen from a water-split reaction, said cartridge comprising:
the consolidated mass of reactant material, said reactant material comprising metallic aluminum and a metal oxide initiator; and
a permeable filter containing said consolidated mass of reactant material, that allows water to enter therethrough so as to produce said reaction with said reactant material that generates hydrogen gas, and that permits said hydrogen gas generated by said reaction to escape therethrough from said mass of reactant material.

24. The cartridge of claim 23, wherein said reactant material further comprises:
a water-soluble salt catalyst that causes progressive pitting of said metallic aluminum.

25. The cartridge of claim 23, further comprising:
an elongate body containing said mass of reactant material into which water is fed progressively from a first end of said body towards a second end thereof.

26. The cartridge of claim 25, further comprising:
means for distributing water across said first end of said elongate body.

27. The cartridge of claim 26, wherein said means for distributing water across said first end of said body comprises:
a layer of open-cell foam material that is mounted to said first end of said body.

28. The cartridge of claim 26, wherein said means for distributing water across said first end of said body comprises:
a layer of blotter material that is mounted to said first end of said body.

29. The cartridge of claim 28, wherein said means for distributing water across said first end of said body further comprises:
a wick member for conveying said water to a portion of said layer of blotter material from which said water is distributed over said first end of said body.

30. The cartridge of claim 25, further comprising:
a tubular housing that contains said elongate body, said tubular housing having a first end proximate said first end of said body and a second end proximate said second end of said body.

31. The cartridge of claim 30, further comprising:
a permeable member mounted at said second end of said tubular housing through which hydrogen generated by said reaction escapes from said cartridge.

32. The cartridge of claim 31, wherein said permeable member comprises:
a porous membrane.

33. The cartridge of claim 23, wherein said permeable filter material comprises:
a mesh material.

34. The cartridge of claim 33, wherein said mesh material comprises:
a fine plastic mesh.
